(19) United States
(12) Patent Application Publication
(10) Pub. No.: US 2005/0284823 A1
(43) Pub. Date: Dec. 29, 2005

(54) Cooking oil filter element and method

(76) Inventors: Ronald E. Fall, Carmel, IN (US); Gary Philip Hammond, Talking Rock, GA (US); Steven N. Cardwell, Fisher, IN (US)

Correspondence Address: DON W. BULSON, 1621 EUCLID AVENUE / 19TH FLOOR, RENNER, OTTO, BOISSELLE & SKLAR, LLP, CLEVELAND, OH, 44115, US

(21) Appl. No.: 10/966,117

(22) Filed: Oct. 15, 2004

Related U.S. Application Data
(60) Provisional application No. 60/582,124, filed on Jun. 23, 2004.

(51) Int. Cl. B01D 29/00

(52) U.S. Cl. 210/767; 210/338; 210/493.1

(57) ABSTRACT

A cooking oil filter element and method are characterized by a filter media having a needled nylon pre-filter media layer and a melt-blown nylon main filter layer. The filter media is pleated and configured in a cylindrical shape, and end caps are attached to the ends of the cylindrical filter media through use of an interlock structure that provides, in addition to an adhesive bond, a mechanical interlock between the end cap and the adhesive.

### RELATED APPLICATIONS

This application claims the benefit of U.S. Provisional Application No. 60/582,124, filed Jun. 23, 2004.

### FIELD OF THE INVENTION

The present invention relates generally to a cooking oil filter element and method of filtering cooking oil. More particularly, the invention relates to a cooking oil filter element having a needled nylon pre-filter, melt-blown nylon filter, and end caps secured thereto.

### BACKGROUND OF THE INVENTION

Cooking oils, such as those used in commercial or institutional deep fryers, tend to become contaminated with moisture, food particles, protein compounds such as fatty acids, lipids and miscellaneous polar compounds, and other various contaminants during frying. Cooking oils may tend to take on the taste and smell of the food cooked therein and this may render the oil unsuitable for cooking other types of foods without changing the cooking oil. The oil itself may also tend to break down chemically after extended use, often causing the oil to exhibit undesirable characteristics such as foaming, smoking and/or malodor. Filtering cooking oil to remove particulate matter, protein compounds and other contaminates on a regular basis extends the useful life of the cooking oil and increases the quality, consistency and appearance of foods which are cooked therein.

In commercial and institutional cooking operations it may be suitable to filter cooking oil as often as every eight hours. Often, it is desirable to continuously filter the cooking oil to achieve the most consistent food product. Continuous filtration of the cooking oil generally requires filtering the cooking oil while it is hot, usually above 300 degrees Fahrenheit. Many types of specialized cooking oil filtering apparatus have been proposed. However, the cooking oil filtration process remains less than satisfactory in extending the life of the cooking oil.

One manner of filtering cooking oil is disclosed in U.S. Pat. No. 4,591,434. This patent discloses an apparatus for a two-step filtration process involving drawing the cooking oil through a relatively coarse filter by means of a vacuum and then pumping the cooking oil through a crepe paper filter. It is also known to use a filtering system with a deep fat fryer for filtering oil on a continuous basis. U.S. Pat. No. 4,668,390 to Hurley et al. discloses such a device wherein the filter element comprises a carbon-impregnated cloth.

Another consideration when filtering cooking oil is over-filtering the cooking oil. Certain compounds are desirable in cooking oil but may be inadvertently removed by conventional cooking oil filters. This is particularly the case when a cooking oil filter approaches the end of its useful life as the pores of the filter media become clogged with contaminants and begin filtering more and more matter from the cooking oil. The removal of the desirable compounds from the cooking oil may decrease the quality of the cooking oil.

Some conventional cooking oil filters remove less and less contaminant matter from the cooking oil as the cooking oil filter element approaches the end of its useful life. This characteristic of some conventional cooking oil filters can be attributed to the deformation of the pore structure of the filter media over time. In particular, the pore structure of cotton and cellulose fiber based filter elements may deform over time from the accumulation of contaminant matter on the filter element and the impinging of the cooking oil upon the filter element during the filtering process. The decrease in the filter element's ability to remove contaminants from the cooking oil ultimately leads to the degradation of the cooking oil thereby necessitating replacement of the cooking oil.

Even when filtered periodically, cooking oil must still be replaced relatively frequently to produce the most consistent food products. Thus, cooking oil represents a significant expense to the food service industry. Typical filtering systems in use in the food service industry often only extend the cooking oil lifetime to around 7 days, as compared to about one day if unfiltered. In addition, the cooking oil filter element itself has a similar life expectancy. However, even frequent replacement of a conventional cooking oil filter element will not dramatically extend cooking oil life because conventional cooking oil filter elements do not provide optimal filtration. Thus, in many commercial and institutional establishments, the maximum time a cooking oil may be used is around 7 days.

### SUMMARY OF THE INVENTION

The present invention provides a cooking oil filter element and method that can significantly extend the useful lifetime of a cooking oil and thereby considerably reduce cooking oil expenses in the food service industry. Further, the present invention provides a cooking oil filter element that has an extended life.

In accordance with one aspect of the invention, a filter element comprises a needled pre-filter layer, in particular a needled nylon pre-filter layer, that has an affinity for protein compound contaminants. More particularly, the cooking oil filter element has a needled nylon pre-filter layer, a main filter layer and a media support layer for supporting the main filter layer and/or the pre-filter layer. The main filter layer can be a melt-blown nylon main filter layer, and a woven wire mesh media can be used as the support layer. In an embodiment, the pre-filter layer, main filter layer and support layer are pleated and configured in a cylindrical shape, and at least one end cap is attached to one of the axial ends of the cylindrical filter media.

In accordance with another aspect of the present invention, a method of filtering cooking oil is characterized by passing the cooking oil through a filter element that includes a needled filter medium made of nylon, or other suitable needled filter material to which proteins (such as polars, lipids and/or fatty acids) have an affinity for binding and/or which has a resistance to compression at least about equal to that of a needled nylon filter medium.

In accordance with yet another aspect of the present invention, a filter element comprises a filter media, and an end cap secured to the filter media with an adhesive. The end cap has at an interior surface thereof an interlock structure around which the adhesive extends to provide a mechanical interlock between the end cap and the adhesive. More particularly, the interlock structure can be a woven wire mesh welded to the end cap.

To the accomplishment of the foregoing and related ends, the invention comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### DRAWINGS

FIG. 1 is a schematic diagram of a cooking oil system including a filter element according to the present invention.

FIG. 2 is a side elevational view of the filter element.

FIG. 3 is a sectional view of the filter element as seen along line 2-2 of FIG. 2.

FIG. 3A is an enlarged fragmentary portion of the filter element.

FIG. 4 is a sectional view of an end cap used in the filter element.

FIG. 5 is a fragmentary enlarged view of the end cap assembled in the filter element.

FIG. 6 is a flow chart of a method of attaching an end cap to a filter element according to the present invention.

### DETAILED DESCRIPTION

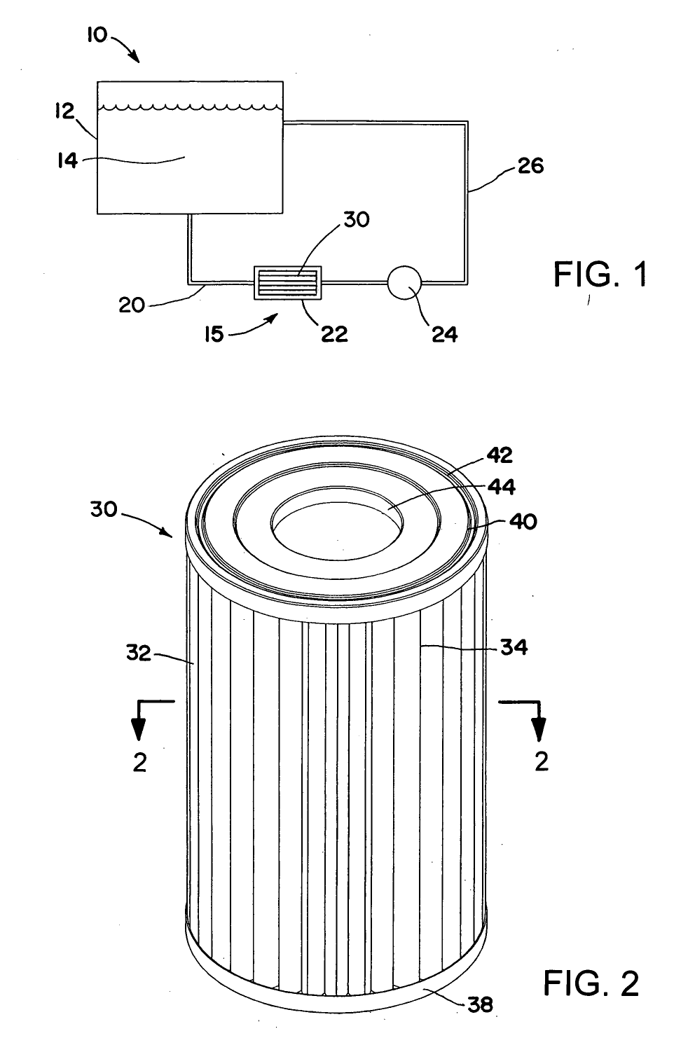

Referring now to the drawings in detail, and initially to FIG. 1, a frying system is schematically illustrated at 10. The frying system 10 includes a vat 12 for holding and heating an edible cooking oil 14 in which food can be cooked. An oil filtration system 15, including an intake pipe 20 having an in-line filter housing 22, a pump 24, and a return pipe 26, is connected to the vat 12. The filter intake pipe 20 connects the bottom of the vat 12 to the pump 24 via the filter housing 22. The return pipe 26 connects the pump 24 back to the vat 12. The filter housing 22 contains a filter element 30 for filtering the cooking oil 14. In this configuration, the pump 24 draws the cooking oil 14 from the bottom of the vat 12 through the filter intake pipe 20 and in-line filter housing 22. The cooking oil 14 is filtered as it passes through the filter element 30. The cooking oil 14 is then pumped back to the vat 12 via the return pipe 26.

Referring to FIG. 2, the filter element 30 includes a pleated cylindrical filter media 32 having a plurality of longitudinal pleats 34. End caps 38 and 40 are attached respectively to the axial ends of the pleated cylindrical filter media 32. One or both end caps can include an annular groove 42 for accommodating a sealing member such as a gasket, as may be desired. One or both end caps can also include an opening 44 for passage of cooking oil into or out of the filter element. In a typical arrangement, opposite ends of the filter element will be sealed to the housing which includes a filter element chamber larger in diameter than the filter element. The portion of the chamber surrounding the filter element can be connected to the cooking oil inlet or outlet, while the other of the cooking oil inlet or outlet will be in communication with the interior of the filter element via the opening in one or both of end caps.

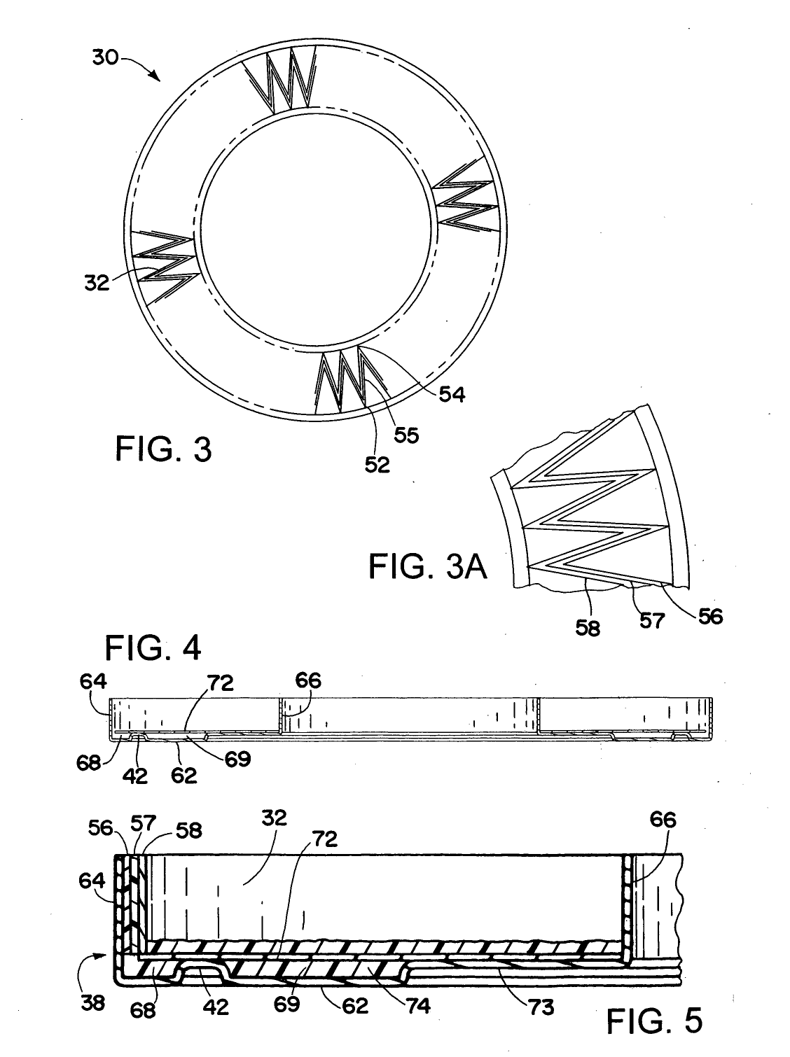

In FIG. 3, the pleats 34 of the filter media 32 can be seen to have radially-outer peaks 52 defining an outer diameter, radially-inner peaks 54 defining an inner diameter, and sidewalls 55 extending therebetween. In the illustrated embodiment, the pleats 34 are generally aligned with the radial dimension of the filter element 30. The number and dimension of the pleats can vary depending upon the particular application. It will be appreciated by those skilled in the art that the filter media 32 can be used in other configurations as desired.

Referring now to FIG. 3A, the filter media 32 can have a multi-layer construction comprising a pre-filter layer 56, a main filter layer 57 and an optional support layer 58. The filter media 32 can be made by compiling the layers 56, 57 and 58 into an appropriately sized sheet and then folding the sheet either by hand or machine to form the pleats 34. The folded sheet of filter media 32 can then be formed into a cylindrical shape and end caps 38 and 40 can be secured to the axial ends thereof, as shown in FIG. 2. Alternatively, the individual layers 56, 57 and 58 can be pleated separately and combined to form the filter media 32. The layers 56, 57 and 58 of the filter media 32 can be bonded together if desired, but usually will not be necessary for most applications.

The pre-filter layer 56 is composed of a needled protein binding material. In a preferred embodiment, the pre-filter layer 56 is composed of needled nylon (felt) and particularly Nylon 66. Nylon 66 is preferred because its higher melting temperature may increase its durability during high temperature filtration, as at temperatures in excess of 300 degrees Fahrenheit, or even in excess of 350 degrees Fahrenheit, or higher. However, other needled protein binding materials, including other needled nylons, may also be suitable for use.

Nylon is in the chemical family of polyamides and acts as a protein binder. Due to the affinity of protein for the needled nylon pre-filter layer 56, protein based contaminants, such as fatty acids, lipids, polar compounds and other amino acids, of virtually all sizes can be filtered from the cooking oil by the pre-filter layer 56. The natural affinity allows for better control of the levels of polars, lipids and fatty acids within the oil, thereby to maintain an acceptable quality level.

The needled nylon pre-filter layer 56 is produced by mechanically interlocking the nylon fibers of a web with reciprocating needles, such needling being a process that is well known. This mechanical interlocking is achieved with thousands of felting needles repeatedly penetrating the web of nylon fibers. The needles intertwine the nylon fibers thereby enhancing the structural stability of the web of fibers. The mechanical interlocking of the nylon fibers also adds dimensional stability to the pores of the needled nylon. The size of the pores may be determined by the particular needling process employed. Thus, the needled nylon pre-filter layer 56 may be adapted for filtering a wide variety of particle sizes by altering the needling process.

It will be appreciated that the needled nylon pre-filter layer 56 is particularly effective at removing protein compound contaminants from the cooking oil due to the increased surface area of the individual nylon fibers. The relatively large fibers of the pre-filter layer 56 produces a material with an increased surface area thereby allowing more protein contaminates to bond thereto.

The fibers of the pre-filter layer 56 may be any suitable diameter. More particularly, the needled nylon pre-filter layer 56 can be composed of fibers ranging from about 10 to about 60 microns in diameter, more particularly from about 20 to about 40 microns in diameter, and still more particularly from about 30 to 35 microns in diameter. Such nylon fibers can be staple fibers that are typically produced by an extrusion process. The needled nylon pre-filter layer 56 can be any suitable thickness such as between about 0.025 and about 0.5 inches, more particularly between about 0.05 and about 0.125 inches, and still more particularly between about 0.065 and about 0.085 inches in thickness. The pre-filter layer 56 can have any suitable mean pore size such as between about 5 and 50 microns, more particularly between 20 and 40 microns, and still more particularly about 30 microns plus or minus 5 microns. The pre-filter layer can have any suitable basis weight such as between about 6 to about 18 oz./yd², more particularly between about 8 to about 14 oz./yd², and still more particularly between about 10 to 12 oz./yd².

The main filter layer 57 can be composed of any suitable filter medium and can be adapted to filter contaminants of a prescribed size from the cooking oil. The filter medium can have a mean pore size between about 2 to about 30 microns, more particularly between about 5 to about 15 microns, and more particularly between about 8 to about 10 microns. The main filter layer can have any suitable efficiency, such as between about 50% and 100%, more particularly between about 80% and 95%, and still more particularly about 90% plus or minus about 2% or 3%. In addition, the main filter layer can have any suitable thickness such as between about 0.002 and about 0.125 inch, more particularly between about 0.005 and about 0.05 inch, and still more particularly about 0.010 inch plus or minus 0.002 or 0.003 inch. The main filter layer 57 can be composed of any suitable diameter fibers such as between 2 and 10 microns, particularly between 4 and 7 microns, and more particularly between 4.5 and 6.5 microns in diameter. In an embodiment the main filter layer 57 is a 10 micron absolute rated melt-blown nylon.

The main filter layer 57 is composed of melt-blown nylon and particularly Nylon 66, as is preferred. However, it will be appreciated that other suitable materials may be suitable for use as the main filter layer 57. Further, nylon (or other materials) made by other processes, such as spun-bonding, may also be suitable. A spun-bonded nylon melt blown media could be calendared to the appropriate mean pore size. The fibers in a spun-bonded filter medium generally are three to four times the diameter generated by the melt blowing process. By use of a secondary calendaring process, the spun-bonded media could be processed to reduce the mean pore size to the above set forth sizes.

The support layer 58 in the illustrated embodiment is a woven stainless steel wire support. However, any conventional support layer structure or material can be used to support the pre-filter layer and filter layer. It will be appreciated that the support layer 58 can be positioned between or on either side of the pre-filter layer 56-and main filter layer 57. Further, more than one support layer 58 can be used as desired to provide adequate support to the pre-filter layer 56 and main filter layer 57.

The flow of the cooking oil through the filter element 30 can be radially-inward through the filter media 32 and out the opening 44 of the end cap 40, as is desired, or reversely with the filter media being appropriately inverted. As the cooking oil 14 is drawn through the filter media 32 the needled nylon pre-filter layer 56 filters protein based contaminants of all sizes and larger conglobated particulate matter from the cooking oil 14. After the cooking oil 14 passes through the needled nylon pre-filter layer 56, the melt-blown nylon filter layer 57 filters the finer contaminants from the cooking oil 14. The melt-blown nylon filter layer 57 generally “polishes” the cooking oil by targeting for removal only specific sizes, types, and amounts of contaminants. As previously mentioned, over-filtering cooking oil can diminish the quality of the cooking oil and thus the ability of the main filter layer 57 to polish the cooking oil 14 by targeting certain types of contaminants for removal.

The needled nylon pre-filter layer 56 prevents premature clogging of the melt-blown main filter layer 57 by filtering protein compound contaminants of all sizes, as well as relatively large conglobated particulate matter, from the cooking oil before such contaminants reach the melt-blown main filter layer 57. Thus, the needled nylon pre-filter layer 56 allows the melt-blown main filter layer 57 to focus on removal of a specific target range of contaminant particle sizes. For example, the pre-filter layer 56 can, for example, filter protein contaminants of all sizes and other contaminants greater than 10 microns from the cooking oil, while the main filter layer 57 targets contaminants, for example, in the 5-10 micron range.

It will be appreciated that the parameters set forth in the previous paragraph represent merely one configuration of a filter element according to the present invention. Other configurations are possible and the previous paragraph in no way limits the possible filter configurations that may be employed in the practice of this invention. It will be appreciated that the configuration of a filter of the present invention is dependent on a wide variety of factors such as the type of cooking oil to be filtered, the type of contaminants to be removed from the cooking oil, the size of the contaminants, etc. Thus, in every application the parameters of the pre-filter layer 56 and the filter layer 57 can be adapted to achieve the desired filtration results.

Turning now to FIGS. 4 and 5, the construction of the filter element 30 with respect to the connection of the end caps 38 and 40 to the filter media 32 will be described. The connection of the end caps 38 and 40 to the filter media 32 will be described with reference to end cap 38, but it will be understood that this description is equally applicable to end cap 40.

As shown in FIG. 4, the end cap 38 has an end-wall 62, a radially-outer circumferential side-wall 64 extending from the end wall 62, and a radially-inner wall 66 extending from the end wall 62. The radially-outer side-wall 64 and radially-inner wall 66 of the end cap 38 may be of any suitable height, thickness, and/or shape depending on a variety of factors including the size of the filter element 30, the thickness of the filter media 32, and other various design factors. Similarly, the spacing between the radially-outer side-wall 64 and radially-inner wall 66 may be any suitable distance. The radially-outer side wall 64 and radially-inner wall 66 define therebetween an annular channel for receiving an end of the filter media 32. The filter media 32 is positioned within this annular channel such that the radially-outer pleats 52 of the filter media 32 are adjacent to the radially-outer circumferential side-wall 64, and the radially-inner pleats 54 of the filter media 32 are adjacent to the radially-inner wall 66.

A wire mesh 72 is disposed between the axial end of the filter media 32 and the end-wall 62 of the end cap 38. The wire mesh 72 can be spot welded to the end cap 38 or otherwise secured to or formed integrally with the end cap 38. The annular groove 42 and a depressed annular region 73 in the end cap 38 serve as supports for the wire mesh 72, thereby creating reservoir regions 68 and 69 inwardly of the end-wall 62 of the end cap 38. As discussed below, these reservoir regions allow adhesive 74 (FIG. 5) to flow around and beneath the wire mesh to create a mechanical interlock between the end cap 38 and the filter media 32.

In FIG. 5, the adhesive 74 is shown occupying the reservoir regions 68 and 69. The adhesive 74 extends upward into the pleats 34 of the filter media 32 and provides an adhesive bond between the filter media 32 and the end cap 38. It will be appreciated that the wire mesh 72 provides an interlock structure around and through which the adhesive 74 can flow thereby forming a mechanical interlock between the adhesive 74 and the end cap 38. Other interlock structures besides a wire mesh can be used. For example, studs with enlarged heads could be provided on the end cap such that the adhesive can flow around and underneath the heads to provide the mechanical interlock in addition to the adhesive bond that is formed. The end cap 38 could also be preformed with a suitable structure for interlocking with the adhesive 74.

Any suitable adhesive can be used to bond the end cap 38 to the filter media 32. For example, the adhesive can be a two-part epoxy adhesive. Given that the cooking oil filter element 30 of the present invention is employed to filter cooking oil used to cook food, the adhesive should not contaminate the cooking oil which in turn may contaminate the food. In addition, the adhesive should be capable of withstanding the high cooking temperatures of the oil. Thus, the adhesive should preferably be a food-grade adhesive capable of withstanding temperatures greater than 300 degrees Fahrenheit, and even temperatures up to 600 degrees Fahrenheit.

It has been found that such high temperature food-grade adhesives do not bond well to the typical materials from which end caps are formed, particularly stainless steel. To overcome this poor bonding problem the present invention provides the above-described mechanism whereby a mechanical interlock can be formed between the end cap and the adhesive.

The end caps 38 and 40 shown and described herein are but one of many end cap designs that may be used. The end caps 38 and 40 can be made of any suitable material, such as rigid plastic, which is compatible with high temperature cooking oil filtration, although stainless steel is generally preferred.

The filter element 30 of the present invention and the method of securing the end caps 38 and 40 to the filter media 32 is not limited to the filter element 30 shown and described herein. It will be appreciated that the device and method of the present embodiment is equally applicable to any filter element where enhanced bonding of an end cap to a filter media is desirable.

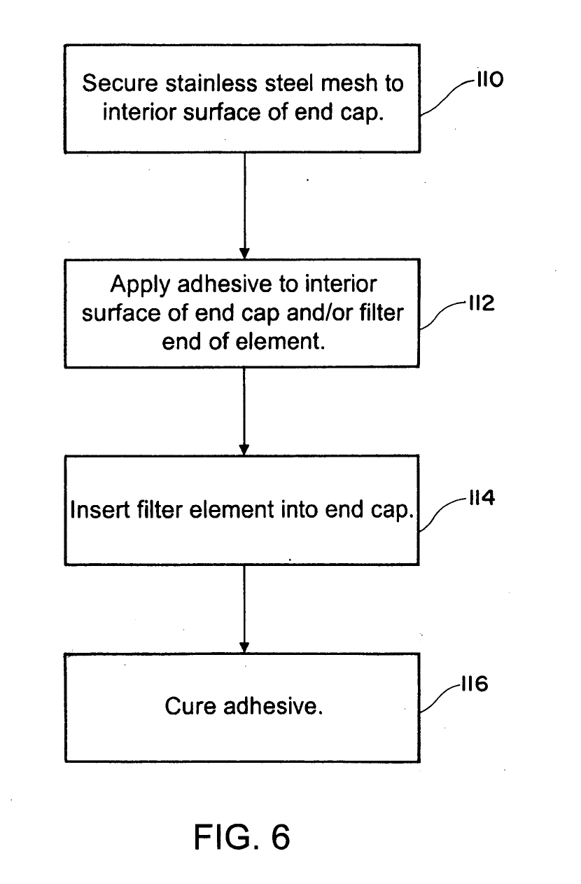

Turning to FIG. 6, a method 100 of attaching an end cap to a filter media will be described. In process step 110, a stainless steel mesh is secured to the interior surface of an end cap to be attached to a filter media. The mesh may be secured to the end cap via spot welding or other suitable methods. An adhesive is then applied to the interior surface of the end cap including the stainless steel wire mesh in process step 112. Alternatively, the adhesive may be applied to the end of the filter media, or to both the filter media and interior surface of the end cap. In process step 114, the filter media is inserted into the end cap such that the end of the filter media is in contact with the adhesive. In this position, the end cap and filter media are in the attached position. The adhesive is then cured in process step 116 thereby attaching the end cap to the filter media. The adhesive can be cured by any suitable method depending on the type of adhesive.

The cooking oil filter element of the present invention can extend dramatically the life of cooking oil. For example, in some applications the cooking oil filter element of the present invention can extend the life of cooking oil as much as four times as long as conventional cooking oil filter elements. This dramatic increase in cooking oil life not only saves money by reducing the need to change the cooking oil, but also improves the consistency of the food cooked therein by maintaining the cooking oil at a more consistent quality for a longer period of time. It has been found that the life of the cooking oil can be extended as much as four times the life of a conventional filter element. Thus, the cooking oil filter element of the present invention can produce a cost savings as well as an increase in overall quality of the food cooked with oil filtered by the filter element of the present invention.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A filter element for filtering a cooking oil comprising a filter media including a needled nylon pre-filter layer and a main filter layer.

2. The filter element of claim 1, wherein the needled nylon pre-filter layer is composed of nylon fibers having a diameter between about 10 and about 60 microns.

3. The filter element of claim 1, wherein the needled nylon pre-filter layer is composed of nylon fibers having a diameter between about 20 and about 40 microns.

4. The filter element of claim 1, wherein the needled nylon pre-filter layer is composed of nylon fibers having a diameter between about 30 and about 35 microns.

5. The filter element of claim 1, wherein the needled nylon pre-filter layer has a mean pore size between about 5 and about 50 microns.

6. The filter element of claim 1, wherein the needled nylon pre-filter layer has a mean pore size between about 20 and about 40 microns.

7. The filter element of claim 1, wherein the needled nylon pre-filter layer has a mean pore size between about 25 and about 35 microns.

8. The filter element of claim 1, wherein the needled nylon pre-filter layer has a thickness between about 0.025 inch and about 0.5 inch.

9. The filter element of claim 1, wherein the needled nylon pre-filter layer has a thickness between about 0.065 inch and about 0.125 inch.

10. The filter element of claim 1, wherein the needled nylon pre-filter layer has a thickness between about 0.065 inch and about 0.085 inch.

11. The filter element of claim 1, wherein the main filter layer is made of melt-blown nylon.

12. The filter element of claim 11, wherein the melt-blown nylon filter layer has a mean pore size between about 2 and about 30 microns.

13. The filter element of claim 11, wherein the melt-blown nylon filter layer has a mean pore size between about 5 and about 15 microns.

14. The filter element of claim 11, wherein the melt-blown nylon filter layer has a mean pore size between about 8 and about 10 microns.

15. The filter element of claim 11, wherein the melt-blown nylon filter layer has an efficiency of between about 80% and 100%.

16. The filter element of claim 11, wherein the melt-blown nylon filter layer is composed of nylon fibers having a diameter between about 2 and about 8 microns.

17. The filter element of claim 11, wherein the melt-blown nylon filter layer has a thickness between about 0.001 inches and about 0.125 inches.

18. The filter element of claim 1, wherein the filter media is pleated and configured in a cylindrical shape, and wherein at least one end cap is secured to an end of the filter media.

19. The filter element of claim 18, wherein the at least one end cap is secured to the filter media with an adhesive, and the at least one end cap has an interlock structure at an interior surface thereof around which the adhesive extends to provide a mechanical interlock between the adhesive and end cap.

20. The filter element of claim 5, wherein the adhesive will not contaminate food via the cooking oil and can withstand temperatures greater than 300 degrees Fahrenheit.

21. The filter element of claim 1, further comprising a media support layer adjacent at least one of the pre-filter layer and the main filter layer.

22. The filter element of claim 21, wherein the media support layer includes a woven wire mesh.

23. A method of filtering a cooking oil comprising passing the cooking oil through a filter media including a needled nylon filter medium.

24. The method of claim 23, including passing the cooking oil through a melt-blown nylon filter medium after it passes through the needled nylon filter medium that functions as a pre-filter layer.

25. The method of claim 15, wherein the cooking oil is at a cooking temperature greater than 300 degrees Fahrenheit.

26. A filter element comprising a filter media; and an end cap secured to the filter media with an adhesive, the end cap having an interlock structure at an interior surface thereof around which the adhesive extends to provide a mechanical interlock between the end cap and the adhesive.

27. The filter element of claim 26, wherein the interlock structure is a wire mesh.

28. The filter element of claim 19, wherein the adhesive is a high temperature food-grade adhesive.

29. A method of attaching an end cap to a filter media comprising:
providing an interlock structure on an interior surface of the end cap;
applying an adhesive to at least one of the end cap and filter media;
inserting the filter media into the end cap; and
curing the adhesive.

30. A filter element for filtering a cooking oil comprising a filter media including a pre-filter layer and a main filter layer, the pre-filter layer being composed of a needled material having an affinity for protein compound contaminants.

31. A method of filtering a cooking oil comprising passing the cooking oil through a filter media including a filter medium composed of a needled material having an affinity for protein compound contaminants.
